(19) United States
(12) Patent Application Publication
(10) Pub. No.: US 2004/0034870 A1
(43) Pub. Date: Feb. 19, 2004

(54) Data streaming system and method

(76) Inventors: Royal J. O'Brien, Jacksonville, FL (US); Mehesh Bajaj, Jacksonville, FL (US)

Correspondence Address: Mark J. Young, McGuireWoods LLP, Suite 3300, 50 North Laura Street, Jacksonville, FL, 32202, US

(21) Appl. No.: 10/639,834

(22) Filed: Aug. 12, 2003

Related U.S. Application Data
(60) Provisional application No. 60/403,129, filed on Aug. 12, 2002.

(51) Int. Cl. G06F 3/00; H04N 5/445; G06F 13/00; H04N 7/173

(52) U.S. Cl. 725/88; 725/89; 725/134; 725/105; 725/92; 725/39

(57) ABSTRACT

A system for streaming data includes a channel for communicating requests between a client and server and another channel for transmitting streaming video. The client creates a media file for archiving received video data. A global list maintained by the client identifies all available data in the media file. A monitoring thread tracks the global list to identify unavailable data needed for playback, identify approaching data discontinuities, merge global list entries for contiguous chunks of available data and identify remaining unavailable data. The client requests unavailable data from the server until the media file is full. A client-side player with a graphical user interface facilitates pause, stop, play, fast forward, jump (scroll), and rewind operations. The system may play video data as streamed and store the streamed video data for playback in a download and store mode.

### PROVISIONAL APPLICATION

This application claims priority to U.S. Provisional Application No. 60/403,129, filed Aug. 12, 2002, the entire contents of which are hereby incorporated by reference herein.

### FIELD OF THE INVENTION

The present invention relates generally to delivering and processing streaming data, and in particular to a system and method for efficient video on demand streaming, storage and playback with interactive features such as pause, rewind and fast forward functionality.

### BACKGROUND

In a video-on-demand (VOD) system, data streams are transmitted from a server to a client (e.g., a PC or set-top box) for playback. Streaming allows users to play data stream segments as received, rather than waiting to receive an entire stream. As viewers have come to expect VCR-style operations, interactive playback features such as pause, rewind and fast forward functions are considered essential to widespread consumer adoption of VOD. However, bandwidth and encoding constraints have heretofore severely limited such interactive functionality.

Thus, a system and method are needed for efficient VOD streaming, storage and playback with interactive features such as pause, rewind and fast forward functionality.

### SUMMARY

It is an object of the present invention to provide a system and method for transmitting, storing and managing video data streams for playback upon receipt and/or at a later time.

It is another object of the present invention to provide a system and method for transmitting, storing and managing video data streams that provide pause, rewind and fast forward functions.

It is another object of the present invention to provide a system and method for transmitting, storing and managing video data streams that enable viewing a video data stream segment multiple times without retransmission.

To achieve these and other objects, a system and method for streaming data from a server to a client are provided. The system provides a channel (i.e., a communications path) for communicating requests between the client and server and another channel for transmitting streaming data. The client creates a media file for archiving received data. A global list maintained by the client identifies all available data in the media file. A monitoring thread tracks the global list to identify unavailable data needed for playback, identify approaching data discontinuities, merge global list entries for contiguous chunks of available data and identify remaining unavailable data. The client requests unavailable data from the server until the media file is full. A client-side player with a graphical user interface facilitates pause, stop, play, fast forward, jump (scroll), and rewind operations. The system may play video data as streamed in a video on demand mode and store the streamed video data for playback in a download and store mode.

In another aspect of the invention, a method for managing the playback of data streamed from a server to a client is provided. The method includes a step of establishing a first channel configured to communicate requests between the client and server. A second channel configured to transmit streaming data from the server to the client in response to the requests is also established. Requests are communicated from the client to the server over the first channel. In response, a data stream is transmitted from the server to the client.

### BRIEF DESCRIPTION OF THE DRAWINGS

The foregoing and other objects, features and advantages of the present invention will become better understood with reference to the following description, appended claims, and accompanying drawings, where:

FIG. 1 provides a high level network diagram that conceptually depicts an exemplary system for video on demand streaming, storage and playback in accordance with the present invention;

FIG. 2 conceptually depicts an exemplary computer system for use as a client and/or server in accordance with a exemplary implementation of the present invention;

FIG. 3 conceptually depicts an exemplary media file containing available data (X) corresponding to a first packet of a video data stream, available data (Z) corresponding to a last independently decodable frame of the video data stream, and unavailable data (zeros), in accordance with a exemplary implementation of the present invention;

FIG. 4 conceptually depicts an exemplary media file containing available data (X) corresponding to a first packet of a video data stream, available data (Z) corresponding to a last independently decodable frame of the video data stream, available data (A) corresponding to other available data, and unavailable data (zeros), in accordance with a exemplary implementation of the present invention;

FIG. 5 conceptually depicts an exemplary player graphical user interface (GUI) for use in accordance with a exemplary implementation of the present invention; and

FIGS. 6 through 22 are flowcharts that conceptually depict steps of an exemplary process in accordance with a exemplary implementation of the present invention.

### DETAILED DESCRIPTION

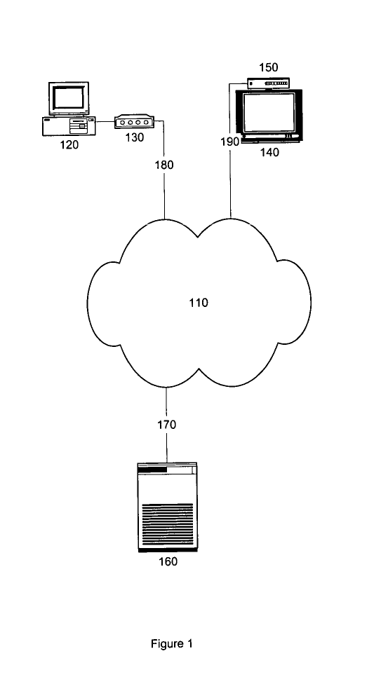

Referring to FIG. 1, a system in accordance with an exemplary implementation of the present invention is conceptually shown. The system includes a plurality of nodes (e.g., clients 120 and 140 and server 160) communicatively connected via a network 110.

Clients may include one or more computers 120 with network connectivity means (e.g., a DSL or cable modem) 130 connected to a transmission medium 180, and/or one or more televisions 140, each having a set-top box 150 (and/or other means for communications, data storage and processing) with network connectivity via a transmission medium 190. Functions of a client preferably include communicating with the server and receiving, storing and processing streamed video data for playback. Each client is communicatively connected to a network 110 such as global computer network (e.g., the Internet), a metropolitan area network, a wide area network (WAN), a local are network (LAN), another network configuration that facilitates communications between the client and a server 160, or some combination of the foregoing.

Each client preferably includes a player, i.e., a client program that enables users to play streamed video data on the client. The player preferably connects the client to a streaming server using a determined protocol to receive a video data stream. The player may manage the receipt, storage and playback of streamed video data. The player may also enable VCR-type interactive functions, such as pause, rewind and fast forward. The player preferably includes means (e.g., software modules or access thereto) for performing all client functions and processes as described herein.

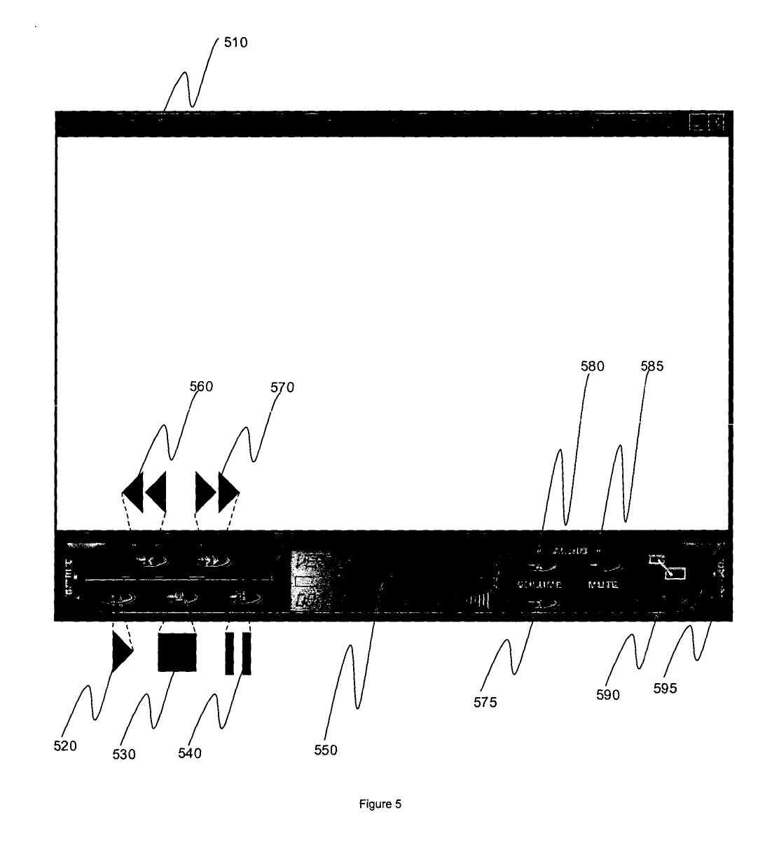

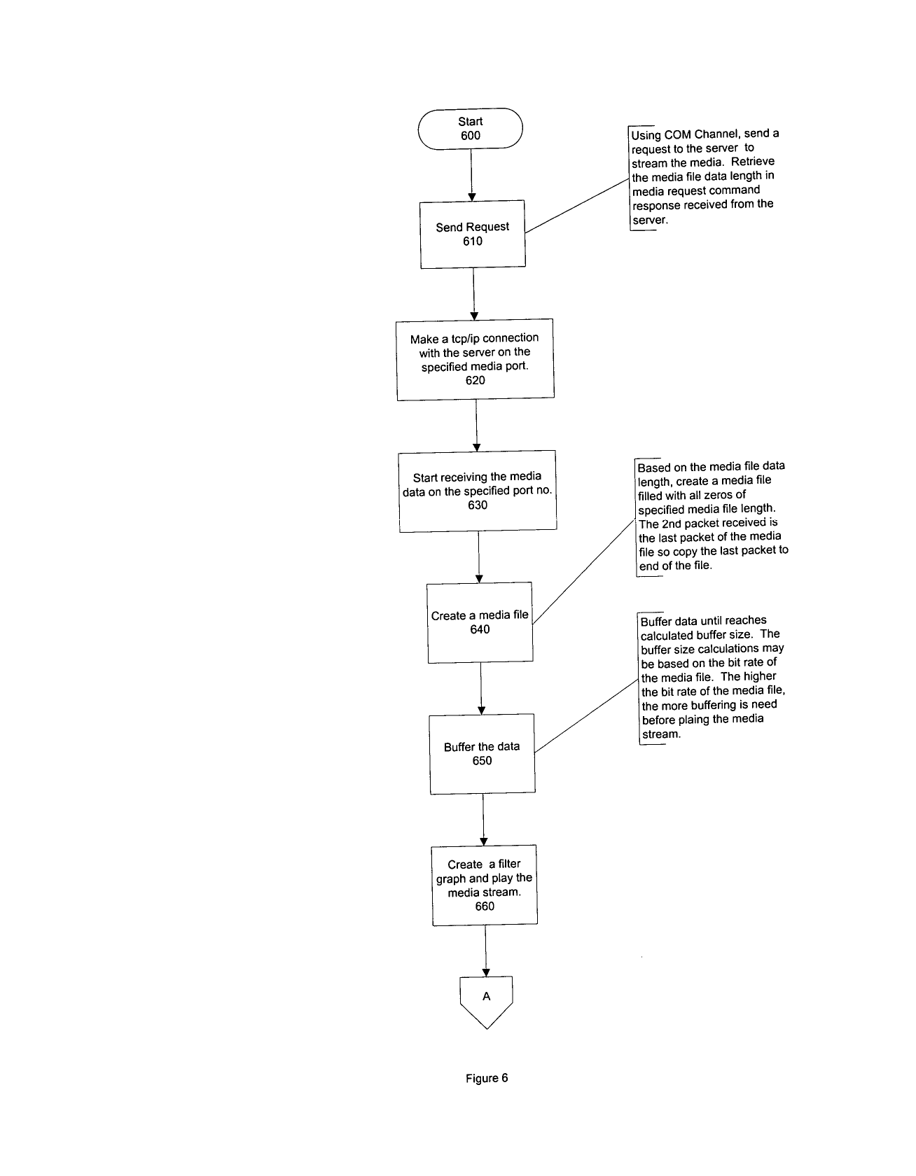

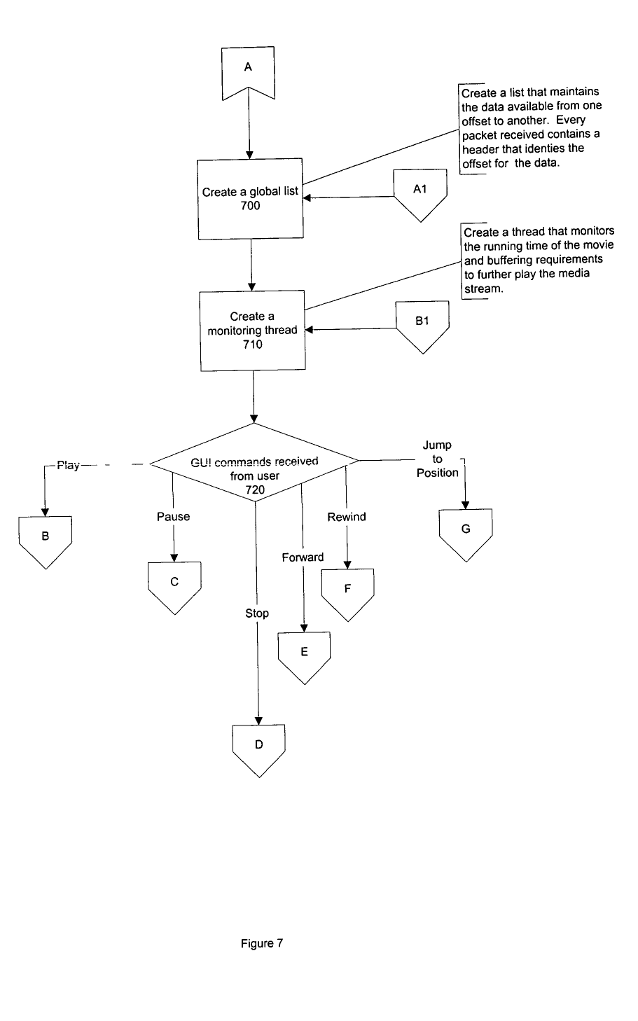

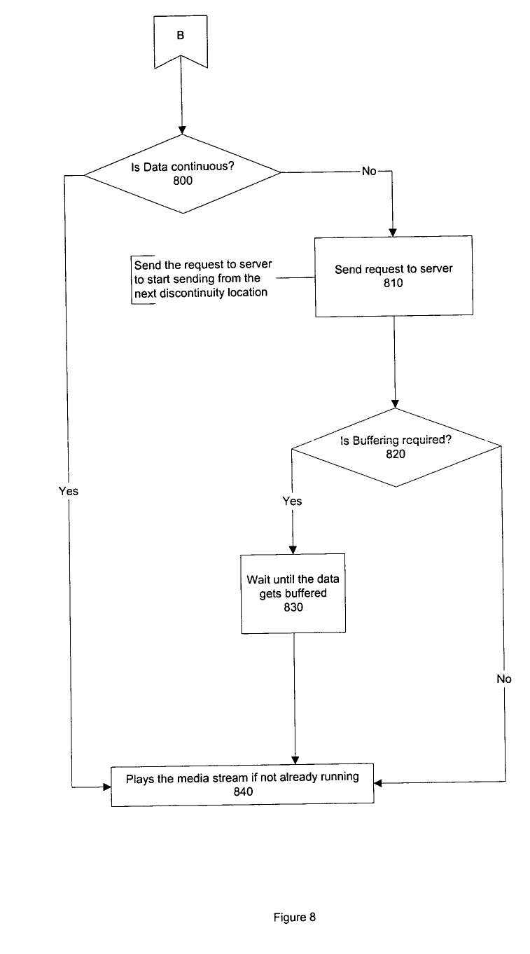

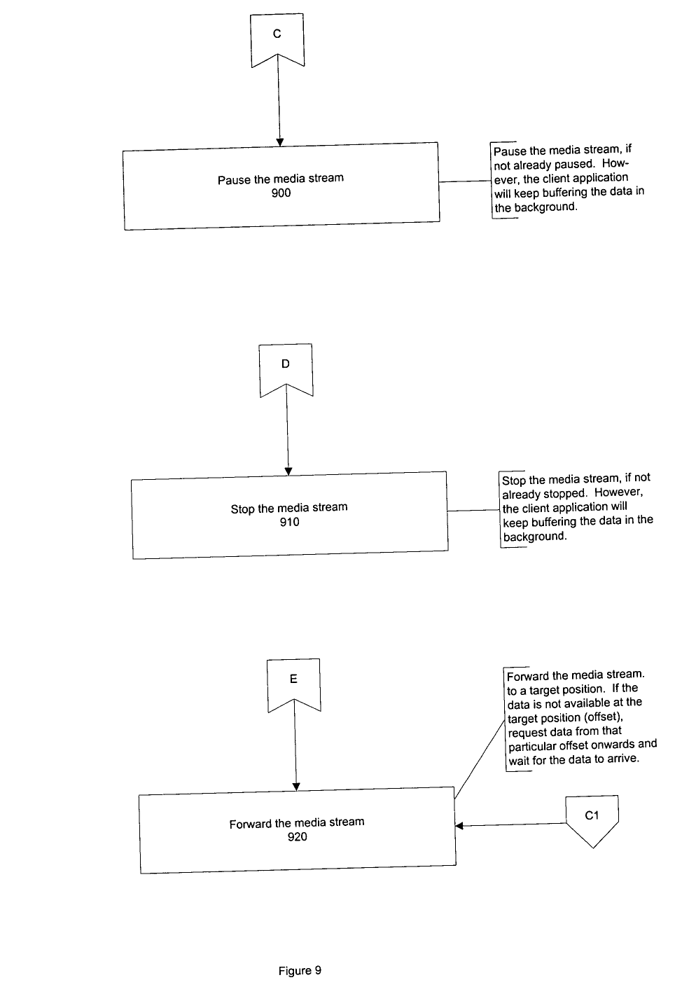

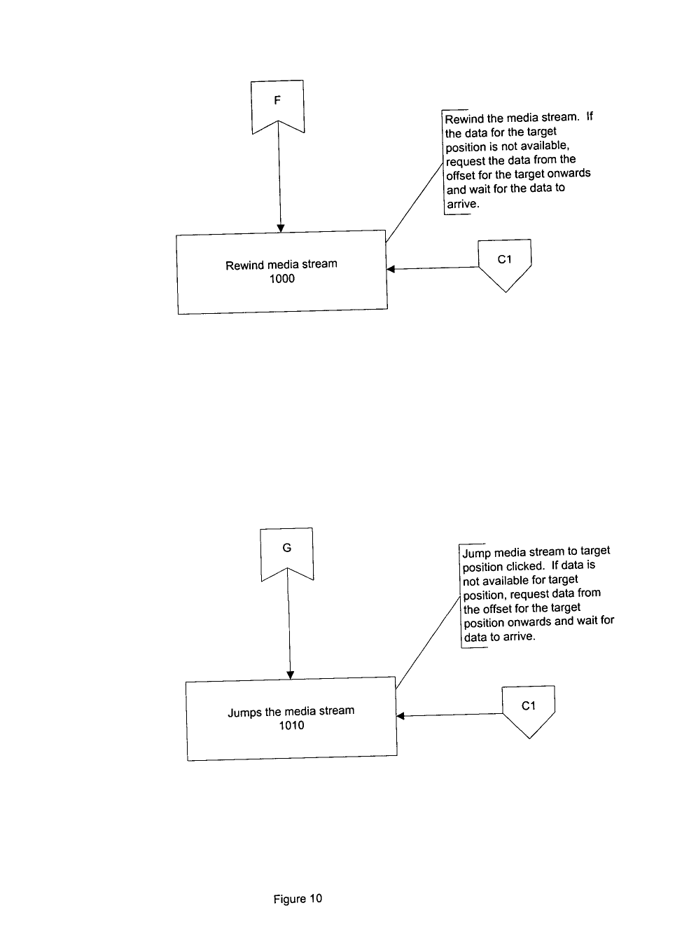

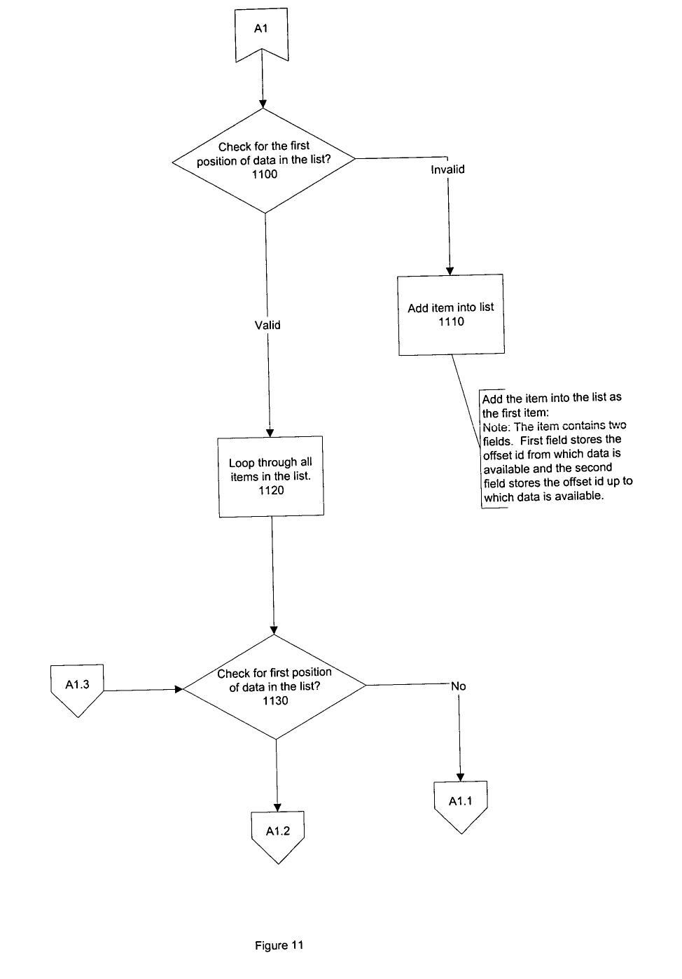

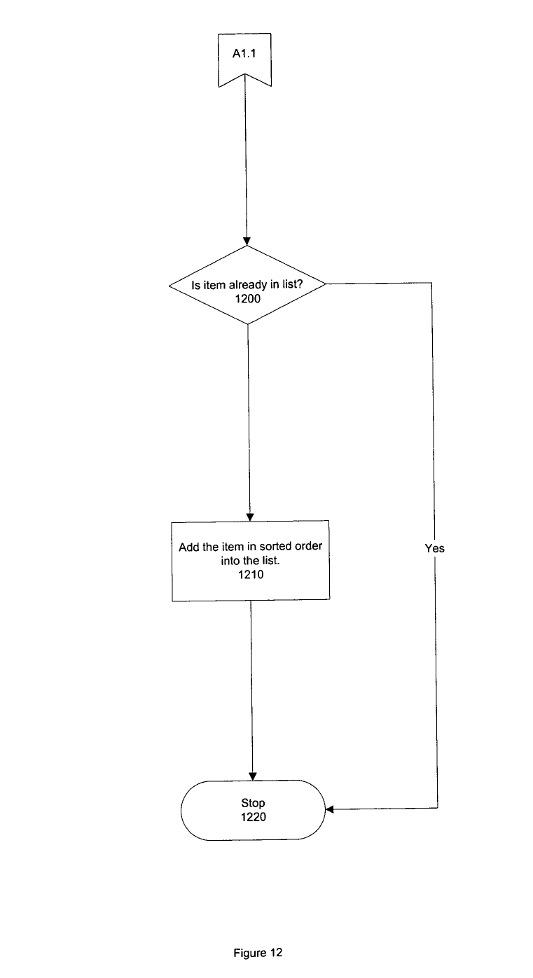

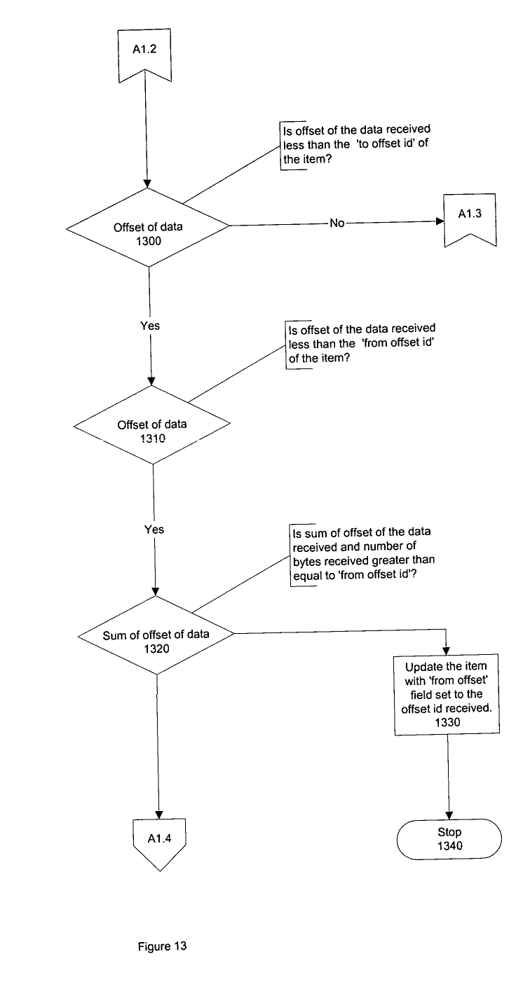

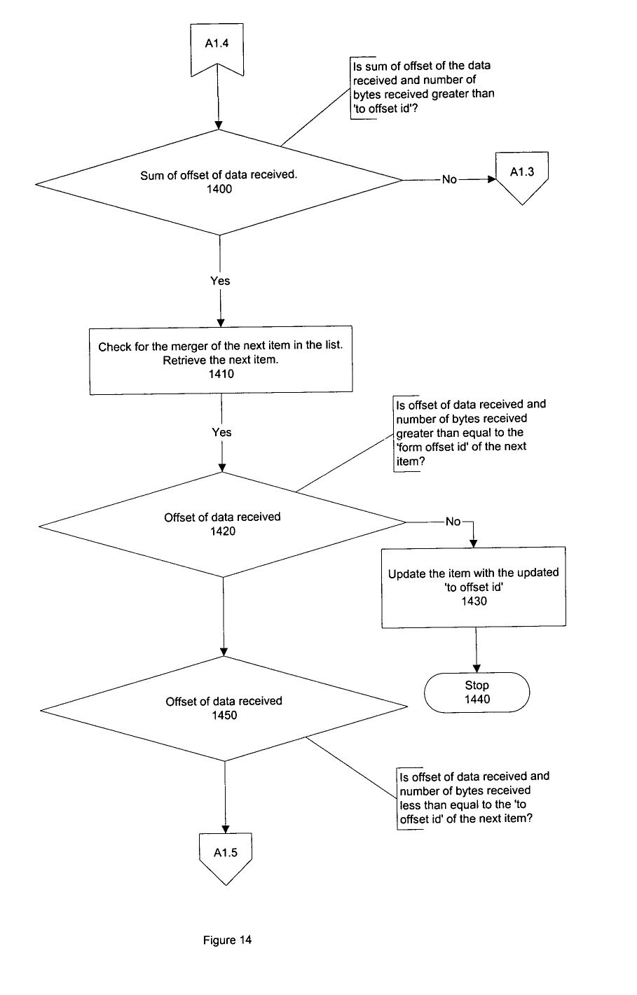

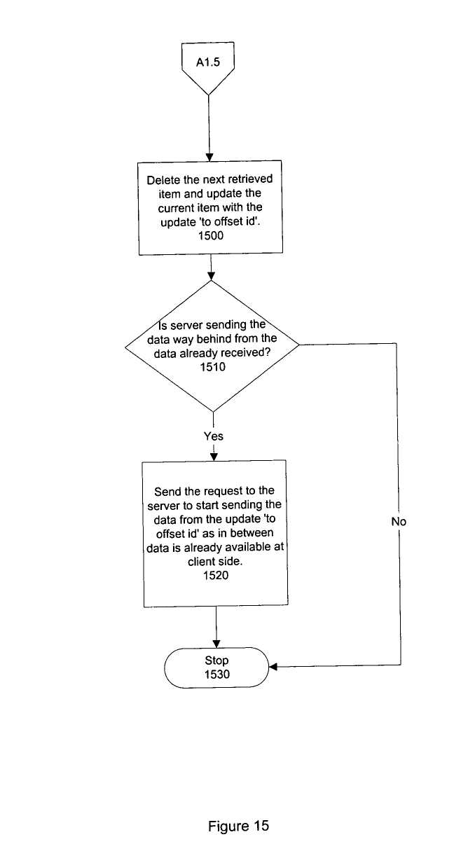

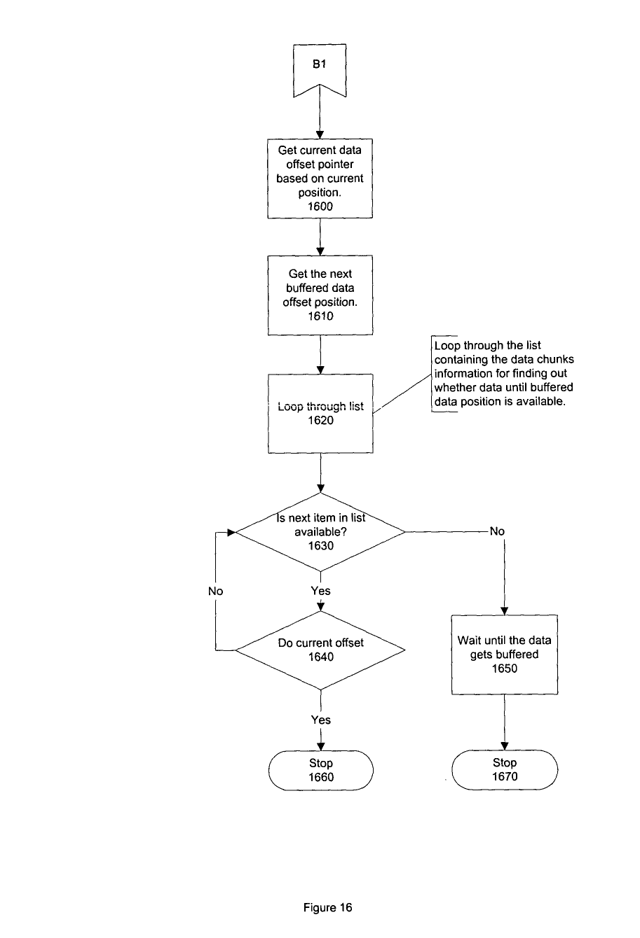

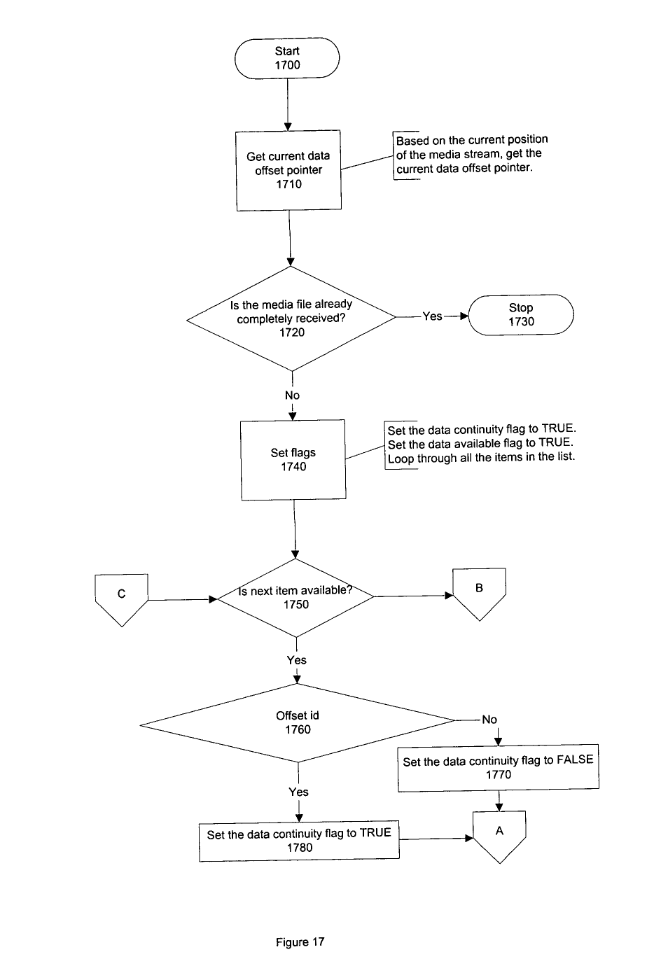

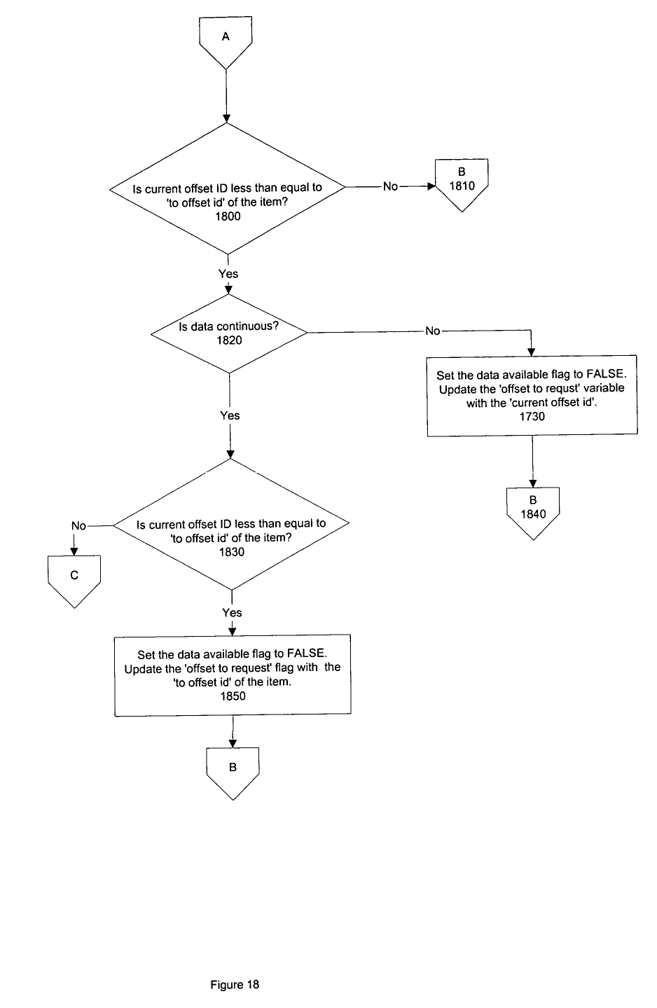

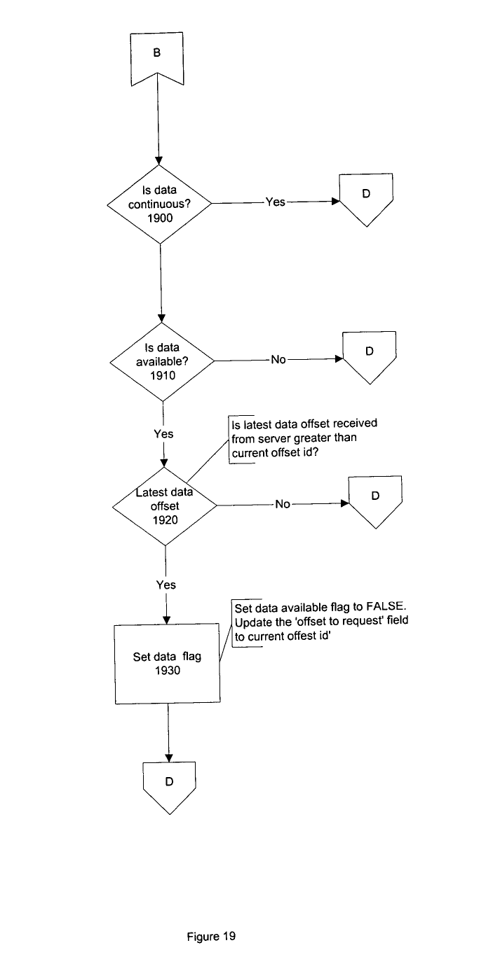

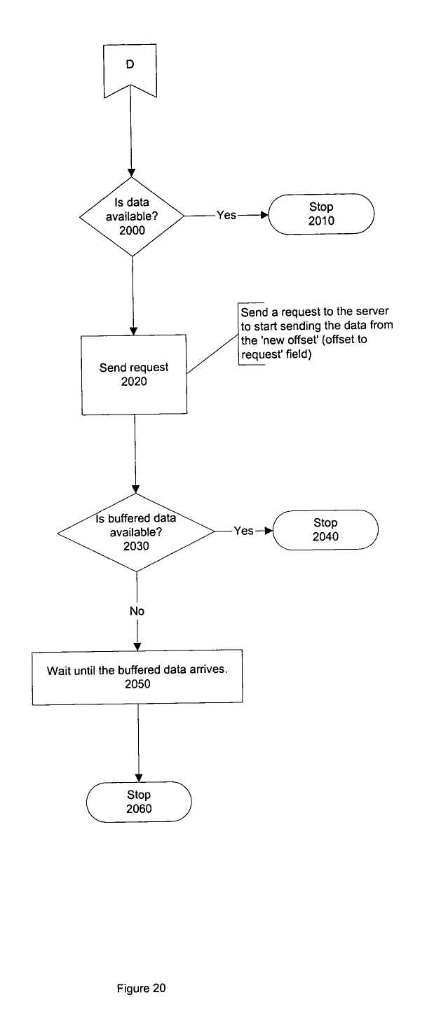

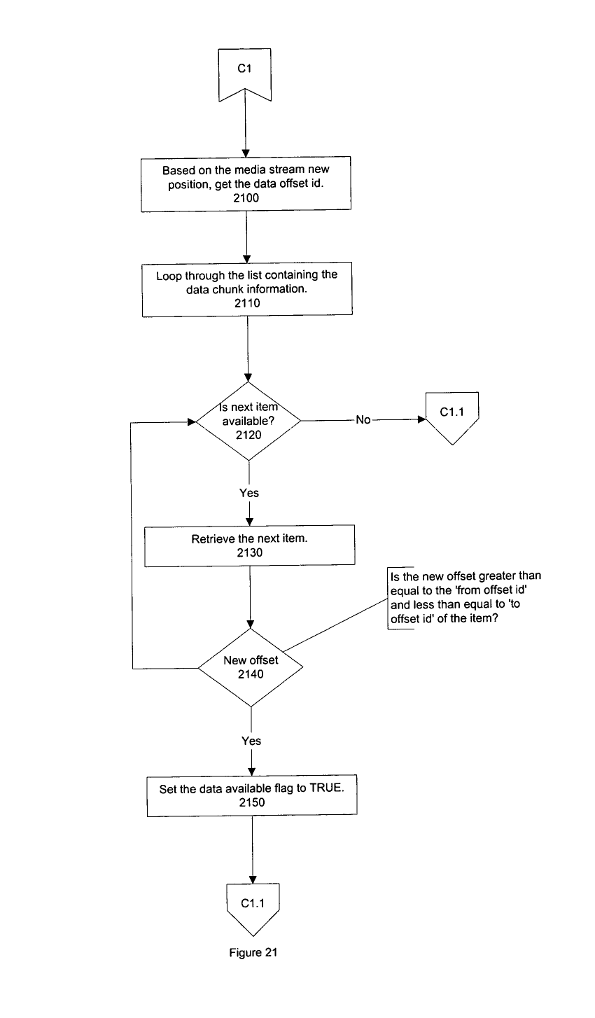

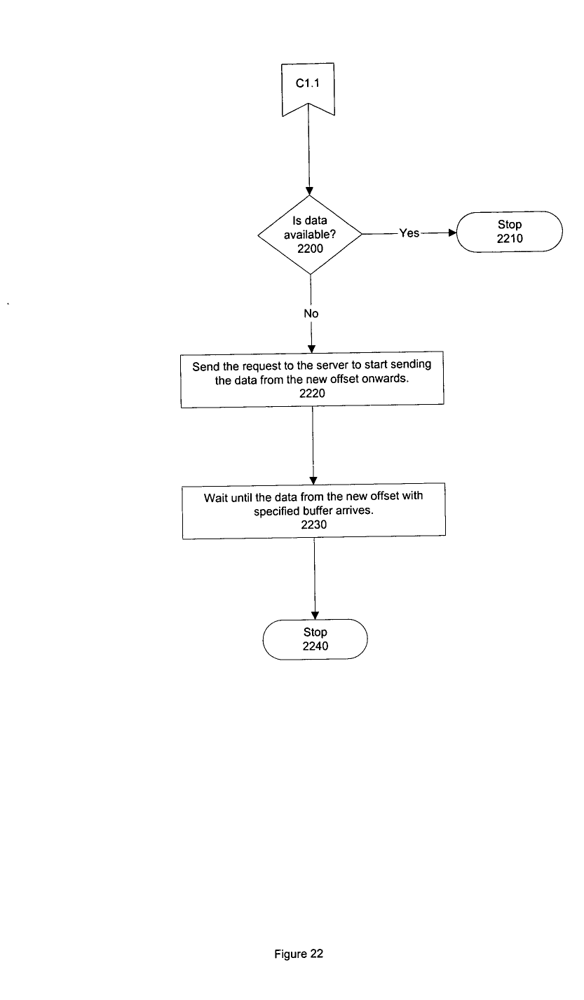

In a exemplary implementation, the player includes a graphical user interface (GUI) to facilitate use. An exemplary GUI 510, 720 shown in FIG. 5, includes play 520, stop 530, pause 540, 900, fast forward 570, 920, and rewind 560, 1000 buttons to activate VCR-type functions and control the playback of video. A scroll bar 550 having a slider 550 indicates the relative position of a frame being played. A user may move the slider 550 along the scroll bar 555 to jump 1010 to another relative position for playback. Volume controls 575-585 enable adjustment of the audio. A control may also be provided to expand the video to full screen 590. An exit button 595 to quit player operation and a help button 515 to access a user guide may also be provided. Of course, a GUI may include fewer, different and/or additional control elements, provided it facilitates user control of playback in accordance with the present invention.

One or more server computers (i.e., servers) 160 are communicatively connected to the network 110 via a transmission medium 170. Functions of a server preferably include processing client requests and transmitting video data streams and/or segments thereof.

The transmission media 170, 180 and 190 may include optical fibers, coaxial cable, twisted copper pairs, satellite links, digital microwave radio, wireless radio links, another data transmission medium, or some combination of the foregoing. The type of network, connectivity and transmission media, along with various other factors (e.g., network congestion), largely determine how fast streamed data may be communicated from a server 160 to a client 120, 140.

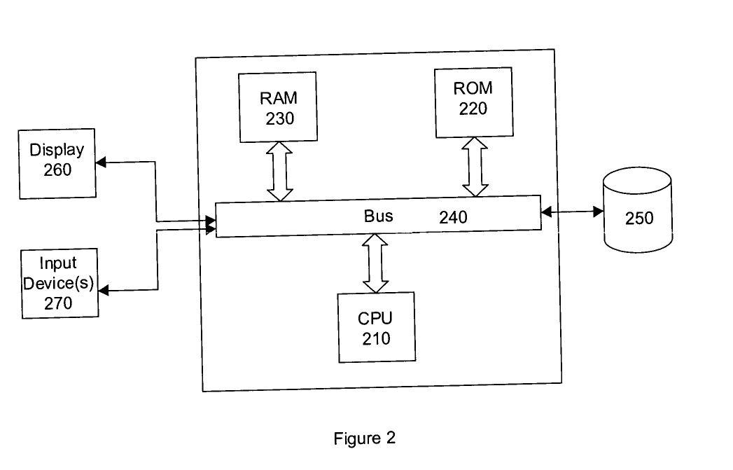

Referring now to FIG. 2, an exemplary computer system for use as a client (such as computer 120 or television 140 and set-top box 150) and/or a server 160 in accordance with the present invention is conceptually shown. The computer preferably includes a bus 240 for communicating information, a central processing unit (CPU) 210, a read only memory (ROM) 220, and a random access memory (RAM) 230. Additionally, a mass storage device 250, a display device 260 and an input device 270 may be provided. The storage device may include a hard disk, tape drive, memory and/or other readable and writable storage means. The input device may include a communications link, a pointing device and/or other means for inputting data. These elements are typically included in most computer systems and the aforementioned system is intended to represent a broad category of systems supporting transmission, receipt, storage and processing of data in accordance with a methodology of the present invention. Of course, the computer system may include fewer, different and/or additional elements, provided it is capable, when programmed, of performing the necessary functions for the node in accordance with the present invention. For example, it may be comprised of a digital signal processor (DSP), an application-specific integrated circuit (ASIC), discrete gate logic, or other hardware, firmware, or any conventional programmable software module and a microprocessor in addition to or in lieu of components described above. The software module could reside in RAM memory, flash memory, registers, or any other form of readable storage medium known in the art. Additionally, the system may either stand alone or operate in a distributed environment.

To substantially reduce bandwidth requirements, video data (including data for audio accompanying the video) are typically encoded before transmission (i.e., streaming). Compression is achieved by reducing redundancies and quantization. Widely accepted encoding standards adopted by the Motion Picture Experts Group (MPEG) include MPEG-1, MPEG-2, and MPEG-4. MPEG encoding utilizes similarities within image frames referred to as spatial or intraframe correlation, to provide intraframe compression in which the motion representations within an image frame (i.e., a portion of a video data stream or file that corresponds to a single image in a sequence of images that comprise the video) are compressed. Intraframes (I frames, a/k/a key frames) are independent of any other frames in the stream. Similarities between successive image frames, referred to as temporal or inter-frame correlation, are also used to provide inter-frame compression in which pixel-based representations of image frames are converted to motion representations. Predictive frames (P frames) are coded using motion estimation and have a dependency on the preceding I or P frame. Interpolated frames (B frames) depend upon the preceding I or P frame and the succeeding I or P frame.

Significantly, the dependencies of B and P frames affect the ability to provide rewind-type and fast forward-type functionality. Neither B nor P frames can be played with acceptable quality unless the frames upon which they depend are available. In contrast, an I frame can be played independently.

While the system and methodology of the present invention are preferably applied to video data that has been encoded and decoded in accordance with MPEG standards (e.g., MPEG-1, MPEG-2 and MPEG-4), those skilled in the art will appreciate that the present invention may be applied to unencoded raw video data and video data encoded using other techniques resulting in dependent and/or independent frames, including possible successors to MPEG-4 and methodologies for video conferencing and video telephony, such as those according to ITU-T standards. As used herein, the term video data refers to data for video and accompanying audio. Those skilled in the art will appreciate that the present invention may be applied to data other than video data, such as audio data for music, speeches, audio books and the like. Such applications come within the scope of the present invention.

A exemplary implementation of the present invention enables (1) archiving and playing streamed video data segments while additional stream segments are being transmitted to the client for archiving and playback and (2) VCR-type operations. Thus, for example, while received segments are being played by the client, unreceived segments are being transmitted to the client. To enable such functionality, the server preferably receives and processes instructions or commands sent by the client and responds accordingly.

In an exemplary implementation, a client may maintain two distinct data channels (i.e., separate logical and/or physical communication paths) with a server, such as (1) a COM channel for communicating requests and responses between the server and client and (2) a media channel for receiving streamed video data from the server 620. Each channel preferably maintains a Transmission Control Protocol/Internet Protocol (TCP/IP) connection with the server. The TCP layer manages the disassembling of a data unit (e.g., a message, data stream segment or file) into smaller packets (or datagrams) that are efficiently transmitted and routed over the network and the reassembling of received packets into the original data unit. The IP layer handles the address part of each packet so that it reaches the intended destination. Use of the TCP/IP protocol helps to ensure that every packet sent by the server is received by the client. The client may use another protocol to interface with a network access provider as an intermediary. For example, the client may use a Serial Line Internet Protocol (SLIP) or Point-to-Point Protocol (PPP) to encapsulate IP packets so that they can be sent over a transmission medium to a network access provider's system without departing from the scope of the present invention.

Initially, an authorized (e.g., authenticated) client may send a request for a video to a server via the COM channel 610. If a video data file for the requested video is available, the server may begin sending (i.e., streaming) the video data via the media channel 630. Upon receiving the first video data packet, the client may send a request to the server via the COM channel for a packet containing the “end offset” of the file, thus identifying the last independent frame (i.e., I frame) of the file to which a fast (or jump) forward operation may be taken. These packets thus contain indexing information for the file.

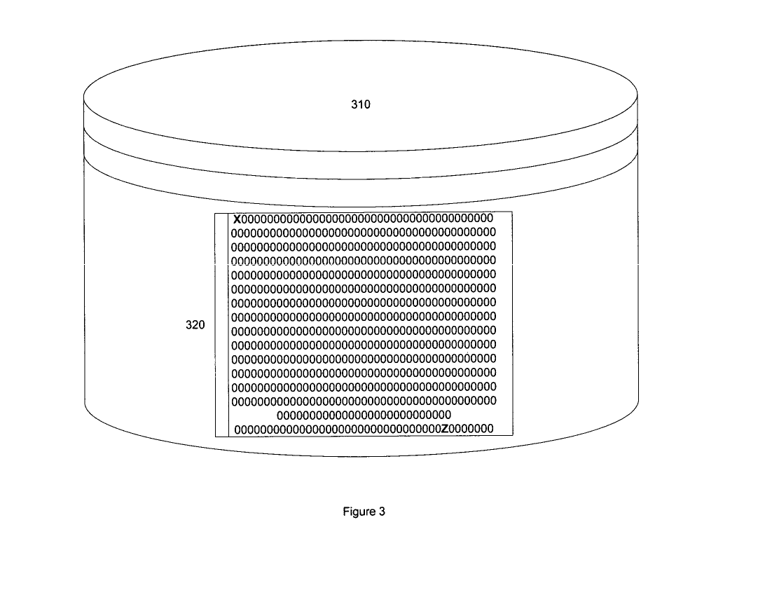

Once the client receives the packet containing the end offset of the video data file via the media channel, the client preferably creates a media file 640 of the video data file size, as conceptually shown in FIG. 3. The video data file size may be obtained from the first packet. The first packet (X) is stored at the beginning of the media file. The packet retrieved from the end offset of the file (Z) is stored near the end position of the file, leaving enough storage space for succeeding frames that may depend upon it. The remainder of the file may then be filled up with zeros, as shown in FIG. 3, specifying empty data chunks. The media file is preferably stored on a storage source, such as volatile or non-volatile memory, a hard disk or some other readable, writable and erasable storage device.

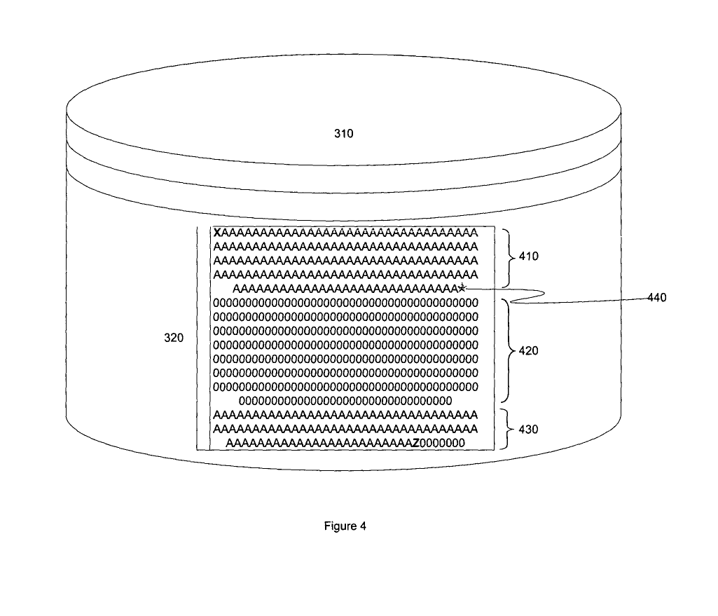

The client preferably maintains a global list 700 that tracks available data (e.g., A, X and Z in FIGS. 3 and 4) and empty data (e.g., zeros in FIGS. 3 and 4) chunks. Items of the global list may be structures defined as follows:

struct {

long IFromOffsetId; // defines the Offset from
which the data is available
long IToOffsetId; // defines the Offset to
which the data is available

};

When the client receives a first media packet, it enters into the global list a ‘from offset id’ as zero and a number of bytes received as ‘to offset id’. This entry indicates that the data from ‘from offset id’ to ‘to offset id’ is available at the client (in the media file). The client updates the ‘to offset id’ entry in the list as additional packets are received.

A monitoring thread 710 instantiated by the client preferably continuously (e.g., every second) tracks (by reference to the global list and/or media file) whether the client has enough data to continue playing the video and whether there are unavailable data in the media file. The amount of data sufficient to continue playing the video may be a buffered amount equivalent to a determined playback time (e.g., 3 seconds), a determined number of frames (e.g., data for 90 frames of video and corresponding audio) or a determined amount of data (e.g., X bits). The amount may be a pre-determined amount or a variable amount determined according to operating conditions such as encoded video bit rate and network data transmission speed. If enough data is not available, the client transmits, via the COM channel, a request to the server to begin sending data immediately succeeding the end of the currently available data chunk (to offset id) and then waits for the new data to arrive.

An important advantage of the exemplary embodiment of the present invention described herein is that it allows a user to jump to any position in the media file irrespective of whether the video data is available or not for that position. If a user jumps to position in the media file, such as by a fast forward scroll forward operation, the monitoring thread similarly tracks whether the client has enough data to keep playing the media from the new current position. If enough data is not available, the client transmits, via the COM channel, a request to the server to begin sending data immediately succeeding the end of the currently available data chunk (to offset id) and then waits for the new data to arrive. A means for transmitting requests, i.e., a request transmitter, may be one or more software, firmware and/or hardware modules, routines, subroutines, applications, functions or some other components configured to transmit desired requests in a format, and using a protocol, compatible with the server.

If a user jumps to a position in the media where data is not available, the client transmits, via the COM channel, a request to the server to begin sending data from that position up to the next available data position. When the data for the new position arrives, a new entry is created in the global list specifying the ‘from offset id’ and ‘to offset id’ and playback may resume. As additional data is received for succeeding positions, the ‘to offset id’ is updated.

The client preferably also tracks the merger of new available data with old available data. As new data is received, filling up previously empty chunks, the global list is updated with each ‘from offset id’ and corresponding ‘to offset id’ entry representing a continuous range of available data 1200. Entries in the global list may be added in an ascending sorted order of ‘from offset id’ 1210.

The client preferably also tracks the sufficiency of buffered data. If network bandwidth is low, playback of the video data stream may reach past available data. To avoid this potential problem, the client may track the amount of data available in the media file ahead of the current position. If the amount of data available is less than a threshold amount, the client may take or initiate a remedial action, such as (for example) pausing and waiting to resume playback (while streaming continues) until the available data to be played next at least equals the threshold. The threshold amount may be a preset amount or an amount determined based on network conditions and/or the bit rate of encoded video. These tracking and remedial functions may be performed by one or more software, firmware and/or hardware modules, routines, subroutines, applications, functions or other components configured to track the sufficiency of buffered data and perform or initiate determined remedial action, referred to herein collectively as a buffering module.

As a user jumps from one media file position to another media file position, data may be available in the form of discontinuous chunks. To avoid problems caused by a discontinuity (i.e., encountering unavailable zero data in the media file), the client application checks for data continuity from the media file current position onwards 800. If the available data is not continuous, the client may send a request, via the COM channel, to the server to send data from the last continuous available data position in the chunk containing the data that is currently being played 810. Received data may be buffered until a threshold amount is available 820, 830.

FIG. 4 conceptually illustrates a media file with several data discontinuities. Locations marked A, X and Z represent available data. Zeros represent unavailable data. If the current play position is at 410, data discontinuity monitoring will cause the client to send a request to the server to begin sending data from the start of the next unavailable data position 420 until the last position of the unavailable chunk 430.

A user can jump to a position in the media file such as by fast forwarding or rewinding, or by manipulating a slider on a scroll bar of a player. The client determines if the targeted data is available (e.g., by checking the global list) before jumping to the targeted position in the media file. In an exemplary implementation, the determination entails determining the current offset id based on the current media position and then determining the data offset required to jump to the new position 2100. Next, the global list is searched to find out whether the data offset for the new position corresponds to available data 2110-2120. If the targeted data is not available, the client will send a request to the server to begin sending data corresponding to an independently decodable frame (e.g., an I frame) at or near the targeted position (e.g., the I frame at the targeted position or the first I frame immediately thereafter if the targeted position does not correspond to an I frame) 2220. The client then waits for the targeted data from new offset to arrive, buffers the data and resumes playback 2230.

Fast forwarding and fast rewinding can be achieved by displaying segments (i.e., portions of the video data stream) at the normal playback rate. Each segment may be either one independently decodable frame (e.g., an I frame) or an independently decodable frame along with one or more dependent frames (e.g., a segment comprised of an I, B, B, B and P frame). Each n^{th} segment ahead or behind may be displayed, or each segment corresponding to a determined time interval position (each x seconds or minutes ahead or behind) in the video may be played. For example, a fast forward operation may display every other, third, fourth or fifth I frame, depending upon the desired fast forward rate. Alternatively, a fast forward operation may display I frames nearest the position in the stream that is x seconds ahead of the then current played frame. If segments used for fast reverse playback include dependent frames, the entire segment must be decoded and buffered before a frame can be displayed. As this increases the buffer requirements at the client and adds to initiation latency, use of segments containing only one independently decodable frame is preferred, at least for fast reverse operations.

Those skilled in the art will appreciate that use of fast forward or jump (scroll) forward operations with streaming video is conducive to formation of discontinuities. Use of fast reverse operations from a point reached in a fast forward or jump (scroll) forward operation may equally be conducive to formation of discontinuities. The methodology described above directs the server to provide data to fill empty chunks in the media file and allow continuous playback from any point in the media file.

When the end of the video data stream has been received and stored in the media file, the monitoring thread preferably checks the global list to determine if any zeros (unavailable data) remain. If zeros remain, the client will send a request to the server to begin sending missing data. For example, the client may send a request, via the COM channel, to the server to send data from the last continuous available data position in the first chunk of available data in the media file up to the data position immediately preceding the next available data. This process may repeat until the entire video data file is stored in the media file.

The methodology of the present invention reduces (or eliminates) the need for retransmission of available data. The monitoring thread does not request the server to send data that is already available in the media file. If sufficient data is available in the media file ahead of the current position, but other data is unavailable, the client will request the unavailable data from the server. Until the media file is full, the client will request unavailable data by reference to the global list and communication with the server via the COM channel.

However, the present invention may, depending upon the implementation, receive available data more than once. For example, the client may request the server to send unavailable data from an offset onwards. When duplicate data arrives, it may be detected as a duplicate by the monitoring thread. In such case, the client may send a request to the server via the channel to begin sending data from a new offset (corresponding to unavailable data) onward. Alternatively, for example, if requests for unavailable data are limited to a range of unavailable data that excludes any available data, the invention may not receive available data more than once.

By employing two channels for communication with the server, the present invention facilitates a steady stream of video data over the dedicated media channel, until the media file is full. Requests sent to the server via the COM channel will not interfere with the video data stream.

An important advantage of the exemplary embodiment of the present invention as described above is that it accommodates both playback of streaming video on demand in real time and playback of downloaded and stored video. If a user pauses or stops playback of streaming video, the client continues to request, via the COM channel, unavailable data from the server, until the media file is full. To illustrate, a user may pause playback by selecting the pause control on a player. Playback will cease. However, the client may continue to request unavailable date (via the COM channel) and the server will continue to send unavailable data (via the media channel) until the media file is full. The media file may then be saved and played back at a time convenient to the user. Playback may start at the beginning of the video or any other position, such as where playback previously ceased.

Another advantage of the exemplary embodiment of the present invention as described above is that it preserves the media file in the event a connection is lost or terminated. Upon reestablishing a network connection streaming may resume via the media channel and communications may resume via the COM channel.

The system and methodology described above use streaming video data as an example. Those skilled in the art will appreciate that the streamed data may be any streaming media, including audio data such as data for music, speeches, audio books and the like.

While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the invention, what I claim as new and desire to secure by Letters Patent is as follows:

1. A system for managing the playback of data streamed from a server to a client, said system including a first channel configured to communicate requests between the client and server, a second channel configured to transmit streaming video from the server to the client in response to said communicated requests, a storage source configured to store received data at the client, an updatable list identifying available data in the storage source, a thread configured to monitor the updatable list to identify unavailable data, and a request transmitter configured to transmit requests to the server for unavailable data.

2. A system according to claim 1, further including a plurality of identifiers for identifying ranges of available data, the identifiers being included in the updatable list.

3. A system according to claim 2, further including at least one control configured to determine a position in the data from which playback should commence, the thread being further configured to monitor the updatable list to identify unavailable data at and ahead of the position in the data from which playback should commence.

4. A system according to claim 3, further including a buffering module configured to track the amount of data ahead of a position corresponding to a playback position.

5. A system according to claim 4, the buffering module being further configured to determine if the amount of data ahead of the position corresponding to the playback position is less than a determined amount.

6. A system according to claim 5, the buffering module being further configured to pause playback until the amount of data ahead of the position corresponding to the playback position equals or exceeds the determined amount.

7. A method for managing the playback of data streamed from a server to a client, said method including steps of
establishing a first channel configured to communicate requests between the client and server,
establishing a second channel configured to transmit streaming data from the server to the client in response to the requests,
communicating one or more requests from the client to the server over the first channel, and
transmitting a data stream from the server to the client in response to the one or more requests.

8. A method according to claim 7, further comprising steps of
creating a media file, and
storing data received by the client from the data stream in the media file according to a position of the data in the data stream.

9. A method according to claim 8, further comprising a step of identifying unavailable data in the media file.

10. A method according to claim 9, further comprising a step of transmitting requests to the server for unavailable data.

11. A method according to claim 10, wherein the step of identifying unavailable data in the media file, further includes a step of providing an updatable list identifying available data stored in the media file.

12. A method according to claim 11, wherein the step of identifying unavailable data in the media file, further includes a step of monitoring the updatable list to identify unavailable data in the media file.

13. A method according to claim 12, further including a step of identifying one or more ranges of available data.

14. A method according to claim 13, further including a step of determining a position in the stored data for playback.

15. A method according to claim 14 further wherein the step of determining a position in the stored data for playback further includes a step of determining a position of data corresponding to a start of an independently decodable frame at or nearby the determined position in the stored data for playback.

16. A method according to claim 14 wherein the step of determining a position in the stored data from which playback will commence further includes determining positions corresponding to a plurality of independently decodable frames and playing the independently decodable frames.

17. A method according to claim 13, further including a step of monitoring the updatable list to identify unavailable data at and ahead of the position in the data from which playback will commence.

18. A method according to claim 17, further including a step of tracking the amount of data ahead of a position corresponding to a playback position.

19. A method according to claim 18, further including a step of determining if the amount of data ahead of the position corresponding to the playback position is less than a determined amount.

20. A method according to claim 19, further including a step of pausing playback until the amount of data ahead of the position corresponding to the playback position equals or exceeds the determined amount.
